(19) United States
(12) Patent Application Publication
(10) Pub. No.: US 2026/0196028 A1
(43) Pub. Date: Jul. 9, 2026

(54) MITOSIS IDENTIFICATION USING A GENERATIVE ADVERSARIAL NETWORK

(71) Applicant: LEICA BIOSYSTEMS IMAGING, INC., Vista, CA (US)

(72) Inventors: Ji WANG, Plainsboro, NJ (US); Chad SALINAS, Rancho Santa Fe, CA (US)

(21) Appl. No.: 19/132,777

(22) PCT Filed: Jan. 26, 2024
(86) PCT No.: PCT/US2024/013093

§ 371 Date: May 23, 2025

Related U.S. Application Data
(60) Provisional application No. 63/442,261, filed on Jan. 31, 2023.

(51) Int. Cl. G06V 10/774; G06V 10/764; G06V 10/82; G06V 20/69

(52) U.S. Cl. CPC G06V 10/774; G06V 10/764; G06V 10/82; G06V 20/698

(57) ABSTRACT

A machine learning model can be trained to add markings to representations of nuclei undergoing mitosis on tissue images. This may include performing a set of training data creation steps, and a set of model training steps. The training data creation steps may include receiving a tissue image comprising a set of representation of nuclei undergoing mitosis, and creating a target image corresponding to the tissue image. The set of model training steps may include providing the tissue image to a generator model, generating an output image based on the tissue image using the generator model, and training the generator model to create improved output images based on differences between the output image and the target image.

### FIELD

The present disclosure relates to processing of histology images using deep learning technology in order to identify cells undergoing mitotic division.

### BACKGROUND

One of the most important topics in the field of microscopy imaging is the classification of cells, typically stained with hematoxylin and eosin (H&E) dye. In this area, one particularly challenging task is the detection of mitotic figures, i.e., cells undergoing division, in tumor tissue. Mitotic figures are defined histologically by the lack of a nuclear membrane and the presence of hairy projections of the chromosomes (nuclear material). A common method for quantification is the mitotic count (MC), which means counting mitotic figures in a standard-sized area located where the tumor is assumed to have the highest mitotic density. It is commonly accepted that the quantity of mitotic figures is one of the most powerful prognosticators of biological behavior for many tumor types, both in humans and animals. However, there are many difficulties associated with this type of mitotic counting. For example, even when histological images are annotated by pathologists, studies have found that there can be significant disagreement, on the order of 17-34% between human annotators in distinguishing individual mitotic figures from other cell structures. Additionally, requiring pathologists to provide annotated images can be a significant barrier to obtaining the data for training algorithms. Accordingly, there is a need for improvements in technology for automatic mitosis identification in histological images.

### SUMMARY

The technology disclosed herein is susceptible to being implemented in a variety of manners. For example, it may be implemented to provide a method for training a machine learning model to add markings to representations of nuclei undergoing mitosis on tissue images. Such a method may comprise performing a set of training data creation steps and a set of model training steps. Where they are performed, training data creation steps may comprise receiving a tissue image comprising a set of representations of nuclei undergoing mitosis, and creating a target image corresponding to the tissue image. In such a case, creating the target image may comprise, for each representation of a nucleus undergoing mitosis from the set of representations of nuclei undergoing mitosis, receiving an identification of a centroid of that representation, and adding a marking to the tissue image at the centroid for that representation. In such a case, the marking added to the tissue image at the centroid for that representation may have a uniform size and shape with all other markings added to the tissue image during performance of the set of training data creation steps. Similarly, in a method which comprises performing a set of model training steps, the model training steps may comprise providing, to a generator model, the tissue image, generating an output image based on the tissue image using the generator model, and training the generator model to create improved output images based on differences between the output image and the target image.

Other types of implementations, including in the form of systems and computer readable media for performing methods as described, are also possible and will be immediately apparent to those of skill in the art in light of this disclosure. Accordingly, the example method provided in this summary should be understood as being illustrative only, and should not be treated as limiting.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts figure illustrates a method which can be used to create input for generative adversarial network training based on a set of annotated histological images;

FIG. 2 illustrates a cropped region which could be treated as a received centroid labeled image;

FIG. 3 illustrates a potential result of repeated addition of markers at centroid locations;

FIG. 4 illustrates an example image pair;

FIG. 5 provides an example of a conditional generative adversarial network (cGAN) architecture which could be used for training such a machine learning model;

FIGS. 6A-6B shows a training method which could be used for a conditional generative adversarial network;

FIG. 7 is a block diagram of a computing apparatus that may be used to implement aspects of the disclosed technology.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to apparatus, systems, and methods for marking nuclei undergoing mitosis in histological images, and for training machine learning models to automatically created such markings. As set forth herein, a deep learning model can be trained using a generative adversarial network to mark cells undergoing mitosis based on training data requiring less complicated annotation than used in many previous approaches. By using this type of approach, systems and methods implemented based on this disclosure may provide benefits such as reducing the effort required in labeling training data, and/or reducing the prediction time relative to use of object detection for identifying mitosis and/or increasing detection performance relative to previous approaches, such as those described in Li, et. Al., Weakly supervised mitosis detection in breast histopathology images using concentric loss, Medical Image Analysis, vol. 53, pages 165-178 (April 2019) or Razavi, et al., MiNuGAN: Dual Segmentation of Mitoses and Nuclei Using Conditional GANs on Multi-center Breast H&E Images, Journal of Pathology Informatics 13 (2022), each of which is hereby incorporated by reference in its entirety.

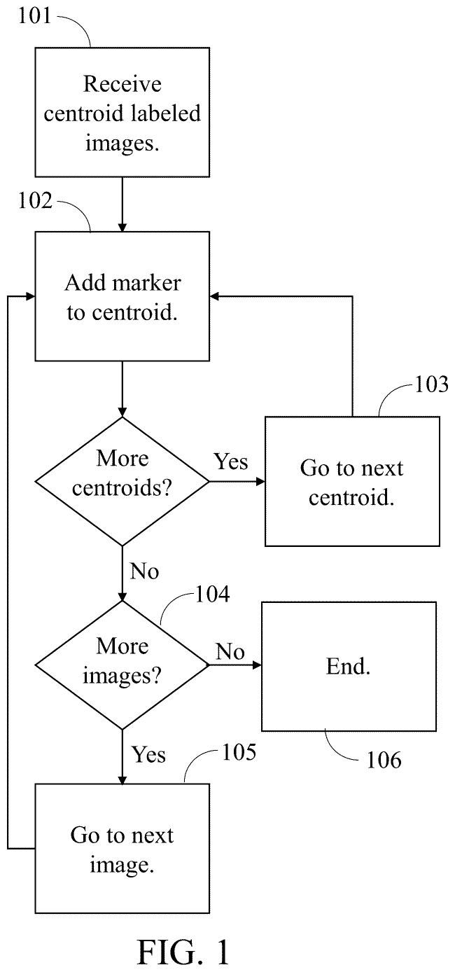

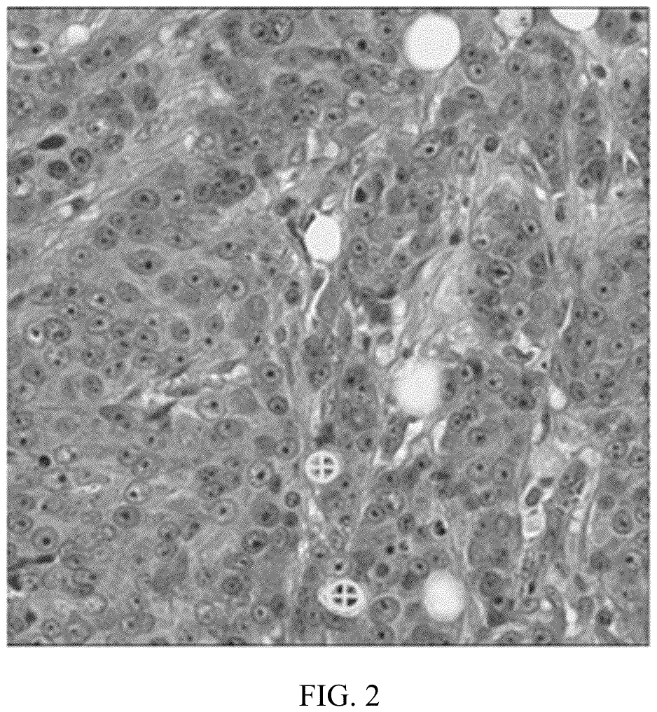

Turning now to FIG. 1, that figure illustrates a method which can be used to create input for generative adversarial network training based on a set of annotated histological images. As shown, such a method may begin with receiving 101 a set of centroid labeled images. This may be done, for example, by receiving one or more H&E stained tissue images where a pathologist has identified nuclei undergoing mitosis and identified a centroid for each of those nuclei, separating each of those images into a set of uniformly sized cropped regions, and then treating the cropped regions which include one or more identified centroids as the received 101 centroid labeled images. An illustration of a cropped region which could be treated as a received 101 centroid labeled image using this approach is provided in FIG. 2, with crosshairs added to indicate identifications of centroids for ease of reference.

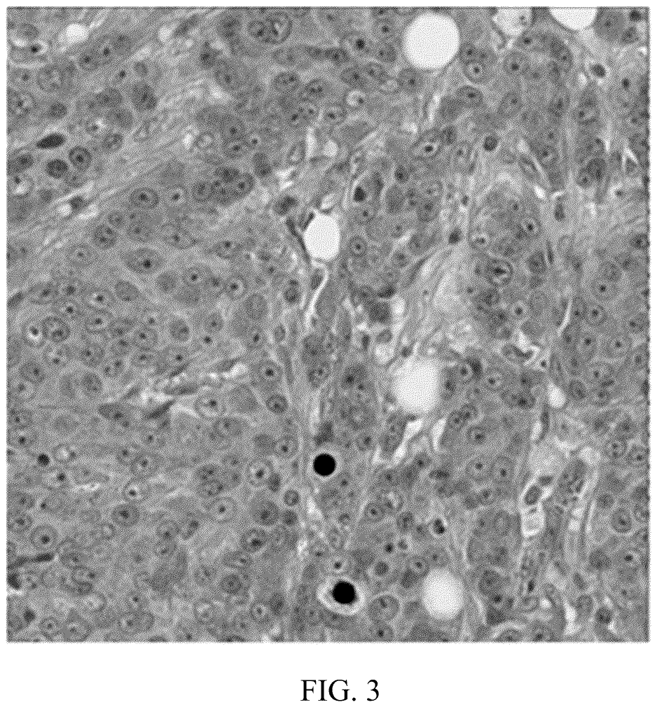

In the method of FIG. 1, once the centroid labeled images had been received 101, they could be processed to create marked images that could be used in generative adversarial network training. As shown, this processing may include modifying one of the received 101 images by adding 102 a marker on one of the identified centroids for that image. This may be done by adding a shape having a size determined by the expected size of a nucleus undergoing mitosis in the receive 101 image. For example, in a case where the received image is a cropped region from an H&E stained tissue image, adding 102 could be done by adding a circle which was centered on the centroid, and having a diameter which 1-2 times the expected diameter of a cell undergoing mitosis, given the magnification of the H&E stained image. This could then be repeated on a centroid by centroid basis, with the method going 103 to the next centroid in the image until a marker had been added 102 for each centroid. An example of a potential result of this repeated addition 102 of markers at the centroid locations is provided in FIG. 3, which shows how the centroid labeled image of FIG. 2 may be modified by the addition of markers as described.

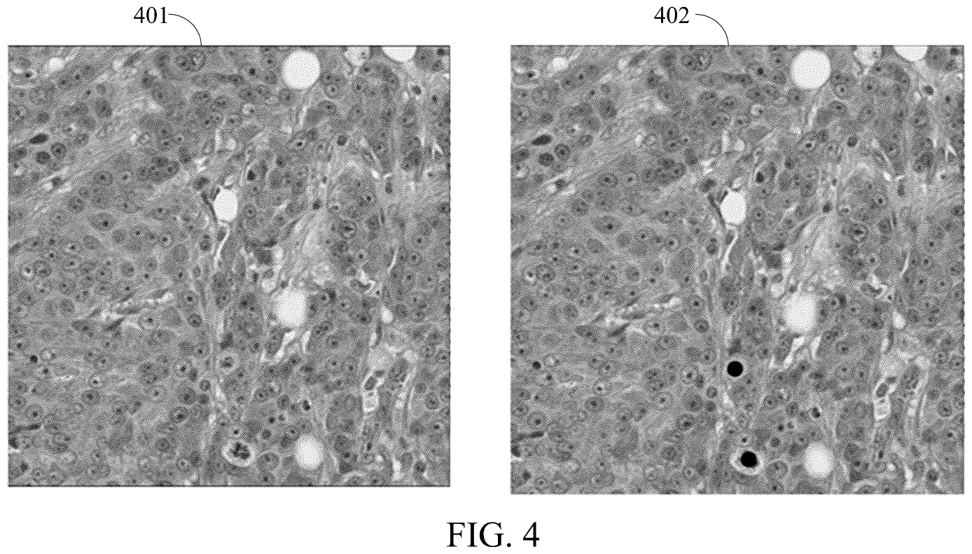

Once markers had been added 102 to all centroids in an image, a check 104 could be performed of whether there were further centroid labeled images to which markers should be added. If there were, then the method could go 105 to the next image, and the processing described above could be repeated for that image. Otherwise, the method could end 106, and provide as output a set of image pairs, in which each pair would comprise both an unmarked H&E stained tissue image, as well as a modified version of that image with markers added as described above. An example of this type of image pair is provided in FIG. 4, which illustrates both an original H&E stained tissue image 401, and a marked image 402 with markings added to identify nuclei undergoing mitosis.

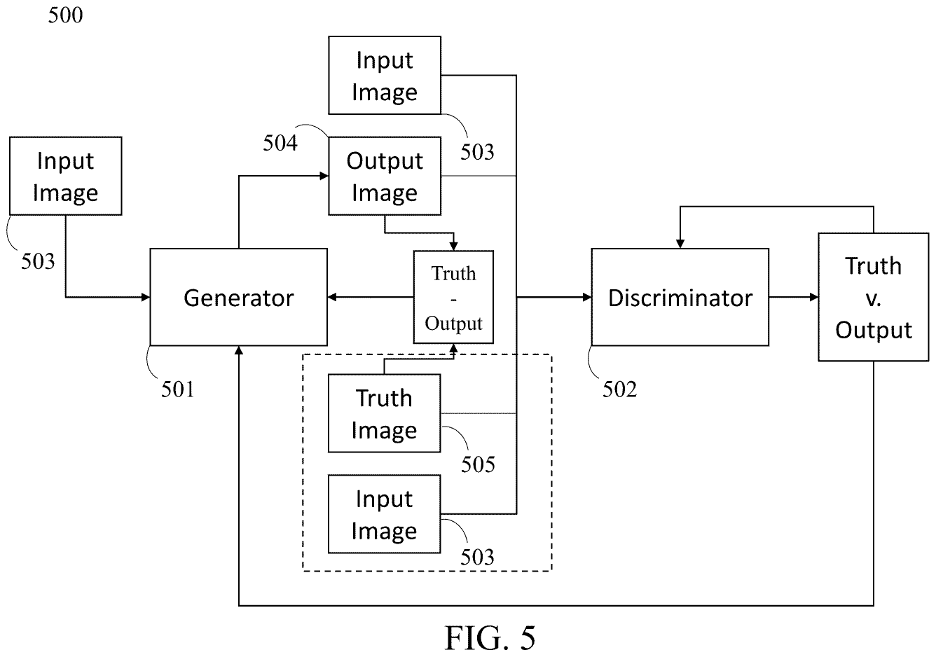

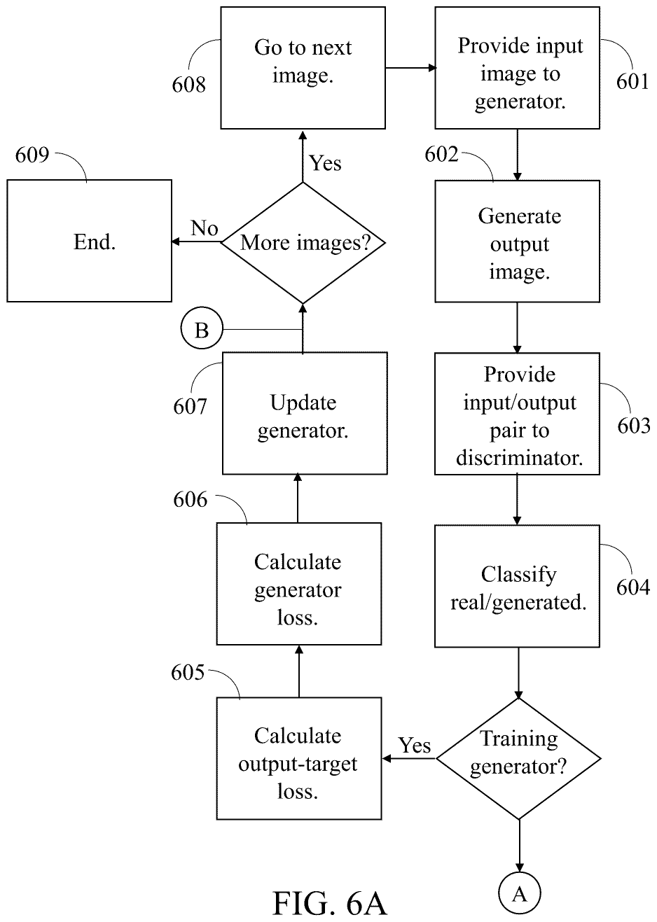

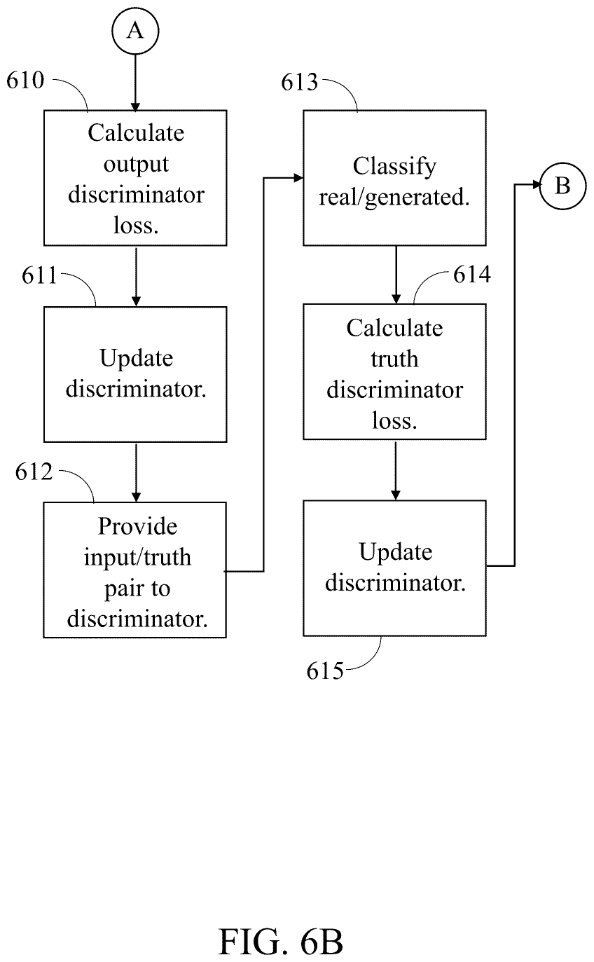

Using training data such as could be generated in a method as shown in FIG. 1, a machine learning model could be trained to automatically add markers to depictions in tissue images of nuclei undergoing mitosis. These marked tissue images could then be used for the diagnosis or treatment of disease, such as the creation of mitotic count values. Such uses could take advantage of the fact that the markers would be much easier to identify than the underlying nuclei, and/or could subtract an original image from a modified image to create a mask made up of the marks added to the mitotic nuclei. An example of a conditional generative adversarial network (cGAN) architecture which could be used for training such a machine learning model is provided in FIG. 5, and a training method which could be performed using this type of conditional generative adversarial network architecture is shown in FIGS. 6A-6B, both of which figures are discussed below.

As shown in FIG. 5, a cGAN 500 could include a generator 501, which may be implemented using an encoder-decoder such as U-Net (described in Ronneberger, et. al., U-net: Convolutional networks for biomedical image segmentation, arXiv:1505.04597v1, the disclosure of which is incorporated by reference herein in its entirety), and trained to generate an output image 504 (e.g., an image with nuclei undergoing mitosis marked) based on an input image 503 (e.g., a tissue image without markings indicating mitosis). A cGAN would also include a discriminator 502, which may be implemented using a classifier (e.g., the PatchGAN convolutional classifier described in Isola, et. al., Image-to-Image Translation with Conditional Adversarial Networks, arXiv:1611.07004v3, the disclosure of which is hereby incorporated in its entirety) which will attempt to distinguish between output images generated by the generator 501 and ground truth images such as marked images created using a process as shown in FIG. 1. As discussed in more detail below, the generator 501 can be trained based on the difference between an output image 504 and a ground truth image 505 corresponding to the input image used to create the output image, as well as on the discriminator's ability to accurately determine that the output image generated by the generator was not a ground truth image. The discriminator 502 can also be trained based on its ability to accurately distinguish between output images from the generator and ground truth images such as created using a method such as shown in FIG. 1, thereby training a model (i.e., the generator 501) to automatically make images which are highly similar to images which would otherwise require significant human input (e.g., identification of centroids by a skilled human pathologist).

As shown in FIG. 6A, during training, an input image (e.g., an original H&E stained tissue image 401) could be provided 601 as input to the generator, and the generator could generate 602 an output image (e.g., a marked image 402, which, before the generator was trained, would likely be largely, if not entirely, random). The input and output images could then be provided 603 as a pair to the discriminator, which could classify 604 the output image (which, in the case of a discriminator such as PatchGAN, may be provide real/generated classifications for portions of the output images) as either real (i.e., a ground truth image) or generated (i.e., created by the generator).

How the real/generated classification is applied may then differ depending on whether the component being trained was the generator 501 or the discriminator 502. For example, in some cases, training may alternate between training the generator and the discriminator, with a first component being trained on a batch of images and a second component being locked during that training, and then training the second component on a batch of images (which may or may not be the same as the batch of images used to train the first component) while the first component was locked. In such a case, with alternating training of the generator and discriminator, if the generator was being trained, an output-target loss could be calculated 605. This calculation 605 may be via calculating an L1 distance between the ground truth marked image corresponding to the applicable input image and the generated image corresponding to the applicable input image using, such as using equation 1, below:

$${ℒ}_{L 1} ( G ) = {𝔼}_{x , y , z} [ {‖ y - G ( x , z ) ‖}_{1} ] \qquad Equation 1$$

In the above equation, L_{L1}(G) is the L1 distance, x and y are, respectively, vector representations of an input image and an output image generated by the generator based on the input image, z is a random noise vector which can be provided to the generator along with the input image to introduce stochasticity, and G(x,z) is a vector representation of the output image created by the generator based on x and z.

Once the output-target loss had been calculated 605, an overall loss for the generator could be calculated 606 using the output-target loss. This overall loss could combine both a loss based on whether the discriminator was able to correctly classify the output image as having been created by the generator (rather than incorrectly classifying it as a ground truth image), as well as the output-target loss, thereby being usable to tune the generator to create images which are both closer to the targets as well as more likely to fool the discriminator. In some implementations, this calculation 606 of a generator loss may also include a weighting value to tune the relative impact of the output-target loss and the loss based on the discriminator's ability to correctly classify the output image. An example of an equation which can be used for this calculation is provided below in equation 2, where Loss_{Final} is the calculated 606 generator loss, Loss_{GAN}(G, D) is the loss based on the discriminator's ability to correctly classify the output of the generator, Loss_{L1}(G) is the L1 distance such as could be calculated using equation 1, and λ is a weighting factor controlling the relative contributions of the different losses to the overall loss for the generator:

$${Loss}_{Final} = {Loss}_{GAN} ( G , D ) + λ {Loss}_{L 1} ( G ) \qquad Equation 2$$

With the generator's loss calculated 606, that loss could then be used to update 607 the generator, such as by back propagation of the loss through the nodes that make up an underlying network, adjusting the values at those nodes to reduce the expected future loss on future calculations. After updating 607 the generator, if there were more images (e.g., if the generator was being updated based on a batch of images, and there were more images in the batch that had not yet been processed) the training process could go 608 to the next image and use that image to repeat the process. Alternatively, if there were no more images, then the process could end. For example, if a training process such as shown in FIG. 6A was being used to train a generator with a batch of images, once all the images in the batch had been used for training the generator, the generator training could end 609 (for that batch), and training could then proceed for the discriminator, such as described below in the context of FIG. 6A.

Turning now to FIG. 6B, as shown in that figure, when the discriminator is being trained, after a generator has generated 602 an output image, the discriminator's ability to correctly classify that input can be used to calculate 610 an output discriminator loss, e.g., a cross entropy loss for portions of a generated output image which are incorrectly identified as being portions of a ground truth image. This output discriminator loss can then be used to update 611 the discriminator, such as using back propagation in a manner similar to that described above in the context of updating 607 the generator. A similar training procedure can then be applied to train the discriminator using ground truth images. Specifically, the discriminator can be provided 612 the input image and its corresponding ground truth image (e.g., a marked image generated from the input image using a process as shown in FIG. 1). It would then classify 613 the ground truth image, a loss would be calculated 614 based on the accuracy of the discriminator's classification, and the discriminator would then be updated 615 based on that loss as appropriate. After this update 615, the process could then go 608 to the next image and repeat if there were more images to be used in training the discriminator or end 609 (which may result in moving to the next batch of images) if training on the input images (or, depending on the context, the input images from a particular training batch) was complete.

Of course, it should be understood that the architecture and training methods discussed above in the context of FIG. 5 and FIGS. 6A and 6B are intended to be illustrative only, and that systems and methods which vary from those illustrations could be implemented by those of skill in the art based on this disclosure without undue experimentation. For example, while the discussion of FIG. 6B described a scenario in which a discriminator was trained with a ground truth image and an output image corresponding to a single input image, it is possible that, rather than using pairs such as described, a discriminator may be trained on batches of images which include output and/or ground truth images which are not related to other images included in that batch. Similarly, while the above discussion described that a random vector could be provided along with an input image as input to a generator, it is possible that such a random vector may be omitted in some implementations, and other measures may be taken to introduce stochasticity (e.g., designating one or more layers in the generator as dropout layers, which are layers configured to randomly set their inputs to 0). Further variations are also possible, and will be immediately apparent to those of skill in the art in light of this disclosure. Accordingly, the above examples, like the discussion of FIGS. 5, 6A and 6B, as well as the other examples and figures in this document, should not be understood as implying limitations on the protection provided by this document or any related document.

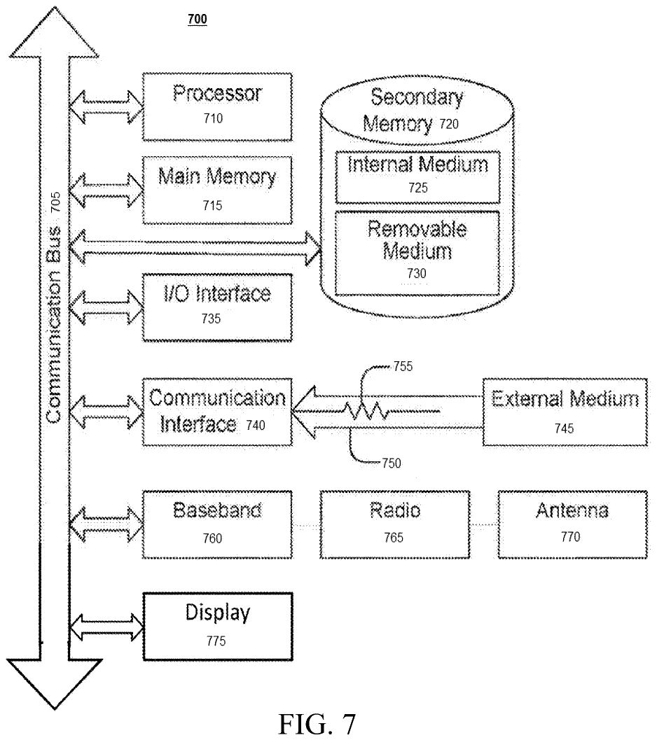

After training as described in the context of FIGS. 5, 6A and 6B, a computer may be configured with a trained generator to take tissue images as input, and automatically generate output images with markings on nuclei undergoing mitosis. An example of a computer system which may be configured in this manner is provided in FIG. 7, which is a block diagram illustrating an example computing apparatus 700 that may be used in connection with various embodiments described herein. Computing apparatus 700 can be a server or any conventional personal computer, or any other processor-enabled device that is capable of wired or wireless data communication. Other computing apparatus, systems and/or architectures may be also used, including devices that are not capable of wired or wireless data communication, as will be clear to those skilled in the art.

Computing apparatus 700 preferably includes one or more processors, such as processor 710. The processor 710 may be for example a CPU, GPU, TPU or arrays or combinations thereof such as CPU and TPU combinations or CPU and GPU combinations. Additional processors may be provided, such as an auxiliary processor to manage input/output, an auxiliary processor to perform floating point mathematical operations (e.g. a TPU), a special-purpose microprocessor having an architecture suitable for fast execution of signal processing algorithms (e.g., digital signal processor, image processor), a slave processor subordinate to the main processing system (e.g., back-end processor), an additional microprocessor or controller for dual or multiple processor systems, or a coprocessor. Such auxiliary processors may be discrete processors or may be integrated with the processor 710. Examples of CPUs which may be used with computing apparatus 700 are, the Pentium processor, Core i7 processor, and Xeon processor, all of which are available from Intel Corporation of Santa Clara, Calif. An example GPU which may be used with computing apparatus 700 is Tesla K80 GPU of Nvidia Corporation, Santa Clara, Calif.

Processor 710 is connected to a communication bus 705. Communication bus 705 may include a data channel for facilitating information transfer between storage and other peripheral components of computing apparatus 700. Communication bus 705 further may provide a set of signals used for communication with processor 710, including a data bus, address bus, and control bus (not shown). Communication bus 705 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Computing apparatus 700 preferably includes a main memory 715 and may also include a secondary memory 720. Main memory 715 provides storage of instructions and data for programs executing on processor 710, such as one or more of the functions and/or modules discussed above. It should be understood that computer readable program instructions stored in the memory and executed by processor 710 may be assembler instructions, instruction-set-architecture (ISA) instructions, machine instructions, machine dependent instructions, microcode, firmware instructions, state-setting data, configuration data for integrated circuitry, or either source code or object code written in and/or compiled from any combination of one or more programming languages, including without limitation Smalltalk, C/C++, Java, JavaScript, Perl, Visual Basic, .NET, and the like, Main memory 715 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Secondary memory 720 may optionally include an internal memory 725 and/or a removable medium 730. Removable medium 730 is read from and/or written to in any well-known manner, Removable storage medium 730 may be, for example, a magnetic tape drive, a compact disc (CD) drive, a digital versatile disc (DVD) drive, other optical drive, a flash memory drive, etc.

Removable storage medium 730 is a non-transitory computer-readable medium having stored thereon computer-executable code (i.e., software) and/or data. The computer software or data stored on removable storage medium 730 is read into computing apparatus 700 for execution by processor 710.

The secondary memory 720 may include other similar elements for allowing computer programs or other data or instructions to be loaded into computing apparatus 700. Such means may include, for example, an external storage medium 745 and a communication interface 740, which allows software and data to be transferred from external storage medium 745 to computing apparatus 700. Examples of external storage medium 745 may include an external hard disk drive, an external optical drive, an external magneto-optical drive, etc. Other examples of secondary memory 720 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, computing apparatus 700 may include a communication interface 740. Communication interface 740 allows software and data to be transferred between computing apparatus 700 and external devices (e.g. printers), networks, or other information sources. For example, computer software or executable code may be transferred to computing apparatus 700 from a network server via communication interface 740, Examples of communication interface 740 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 750 with a network or another computing device. Communication interface 740 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 740 are generally in the form of electrical communication signals 755. These signals 755 may be provided to communication interface 740 via a communication channel 750. In an embodiment, communication channel 750 may be a wired or wireless network, or any variety of other communication links. Communication channel 750 carries signals 755 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs or software) is stored in main memory 715 and/or the secondary memory 720. Computer programs can also be received via communication interface 740 and stored in main memory 715 and/or secondary memory 720. Such computer programs, when executed, enable computing apparatus 700 to perform the various functions of the disclosed embodiments as described elsewhere herein.

In this document, the term “computer-readable medium” is used to refer to any non-transitory computer-readable storage media used to provide computer-executable code (e.g., software and computer programs) to computing apparatus 700. Examples of such media include main memory 715, secondary memory 720 (including internal memory 725, removable medium 730, and external storage medium 745), and any peripheral device communicatively coupled with communication interface 740 (including a network information server or other network device). These non-transitory computer-readable media are means for providing executable code, programming instructions, and software to computing apparatus 500. In an embodiment that is implemented using software, the software may be stored on a computer-readable medium and loaded into computing apparatus 700 by way of removable medium 730, I/O interface 735, or communication interface 740. In such an embodiment, the software is loaded into computing apparatus 700 in the form of electrical communication signals 755. The software, when executed by processor 710, preferably causes processor 710 to perform the features and functions described elsewhere herein.

I/O interface 735 provides an interface between one or more components of computing apparatus 700 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

Computing apparatus 700 also includes optional wireless communication components that facilitate wireless communication over a voice network and/or a data network. The wireless communication components comprise an antenna system 770, a radio system 765, and a baseband system 760. In computing apparatus 700, radio frequency (RF) signals are transmitted and received over the air by antenna system 770 under the management of radio system 765.

Antenna system 770 may comprise one or more antennae and one or more multiplexors (not shown) that perform a switching function to provide antenna system 770 with transmit and receive signal paths. In the receive path, received RF signals can be coupled from a multiplexor to a low noise amplifier (not shown) that amplifies the received RF signal and sends the amplified signal to radio system 765.

Radio system 765 may comprise one or more radios that are configured to communicate over various frequencies. In an embodiment, radio system 765 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 765 to baseband system 760.

If the received signal contains audio information, then baseband system 760 decodes the signal and converts it to an analog signal. Then the signal is amplified and sent to a speaker. Baseband system 760 also receives analog audio signals from a microphone. These analog audio signals are converted to digital signals and encoded by baseband system 760. Baseband system 760 also codes the digital signals for transmission and generates a baseband transmit audio signal that is routed to the modulator portion of radio system 765. The modulator mixes the baseband transmit audio signal with an RF carrier signal generating an RF transmit signal that is routed to antenna system 770 and may pass through a power amplifier (not shown). The power amplifier amplifies the RF transmit signal and routes it to antenna system 770 where the signal is switched to the antenna port for transmission.

Baseband system 760 is also communicatively coupled with processor 710, which may be a central processing unit (CPU). Processor 710 has access to data storage areas 715 and 720. Processor 710 is preferably configured to execute instructions (i.e., computer programs or software) that can be stored in main memory 715 or secondary memory 720. Computer programs can also be received from baseband processor 760 and stored in main memory 710 or in secondary memory 720, or executed upon receipt. Such computer programs, when executed, enable computing apparatus 700 to perform the various functions of the disclosed embodiments. For example, data storage areas 715 or 720 may include various software modules.

The computing apparatus further comprises a display 775 directly attached to the communication bus 705 which may be provided instead of or addition to any display connected to the I/O interface 735 referred to above.

Various embodiments may also be implemented primarily in hardware using, for example, components such as application specific integrated circuits (ASICs), programmable logic arrays (PLA), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method comprising training a machine learning model to add markings to representations of nuclei undergoing mitosis on tissue images by: a) performing a set of training data creation steps comprising: i) receiving a tissue image comprising a set of representations of nuclei undergoing mitosis; and ii) create a target image corresponding to the tissue image by, for each representation of a nucleus undergoing mitosis from the set of representations of nuclei undergoing mitosis: A) receiving an identification of a centroid of that representation; B) adding a marking to the tissue image at the centroid for that representation, wherein the marking added to the tissue image at the centroid for that representation has a uniform size and shape with all other markings added to the tissue image during performance of the set of training data creation steps; and b) performing a set of model training steps comprising: i) providing, to a generator model, the tissue image; ii) generating an output image based on the tissue image using the generator model; and iii) training the generator model to create improved output images based on differences between: A) the output image based on the tissue image; and B) the target image corresponding to tissue image.

### Example 2

The method of example 1, wherein: a) the set of model training steps comprises: i) providing, to a discriminator model, a first paired input comprising the tissue image and the output image based on the tissue image; ii) classifying, using the discriminator model, the output image based on the tissue image as belonging to a class selected from: A) generated images, wherein generated images is a class for all output images generated by the generator model; and B) target images, wherein target images is a class for all target images created in performing the set of training data creation steps; and b) training the generator model to create improved output images is further based on the discriminator model classifying the output image based on the tissue image as a generated image.

### Example 3

The method of example 2, wherein: a) the set of model training steps comprises: i) providing, to the discriminator model, a second paired input comprising the tissue image and the target image corresponding to the tissue image; ii) classifying, using the discriminator model, the output based on the tissue image as belonging to a class selected from: A) generated images; and B) target images; and b) training the discriminator model to create improved classifications based on the discriminator model classifying the target image corresponding to the tissue image as a generated image.

### Example 4

The method of example 3, wherein the set of model training steps comprises alternately training the generator model and the discriminator model on batches of tissue images, wherein the generator model is locked while the discriminator model is being trained, and wherein the discriminator model is locked while the generator model is being trained.

### Example 5

The method of example 2, wherein: a) the generator model is an encoder-decoder; and b) the discriminator model is a classifier configured to provide a classification of either generated image or target image for each of a plurality of patches each paired input.

### Example 6

The method of example 5, wherein the generator model is a U-Net encoder-decoder, and the discriminator model is a PatchGAN classifier.

### Example 7

The method of example 2, wherein the method comprises, after performing the set of model training steps configuring a computer to add markings to representations of nuclei undergoing mitosis in tissue images by configuring the computer with the generator model without configuring the computer with the discriminator model.

### Example 8

The method of example 1, wherein the method comprises, after performing the set of model training steps, providing the generator model as the machine learning model to add markings to representations of nuclei undergoing mitosis on tissue images, wherein the generator model provided as the machine learning model to add markings to representations of nuclei undergoing mitosis on tissue images comprises one or more dropout layers.

### Example 9

A system for training a machine learning model to add markings to representations of cell nuclei undergoing mitosis on tissue images, the system comprising a processor configured with a set of computer executable instructions operable to, on execution, perform a method comprising: a) performing a set of training data creation steps comprising: i) receiving a tissue image comprising a set of representations of nuclei undergoing mitosis; and ii) create a target image corresponding to the tissue image by, for each representation of a nucleus undergoing mitosis from the set of representations of nuclei undergoing mitosis: A) receiving an identification of a centroid of that representation; B) adding a marking to the tissue image at the centroid for that representation, wherein the marking added to the tissue image at the centroid for that representation has a uniform size and shape with all other markings added to the tissue image during performance of the set of training data creation steps; and b) performing a set of model training steps comprising: i) providing, to a generator model, the tissue image; ii) generating an output image based on the tissue image using the generator model; and iii) training the generator model to create improved output images based on differences between: A) the output image based on the tissue image; and B) the target image corresponding to tissue image.

### Example 10

The system of example 9, wherein: a) the set of model training steps comprises: i) providing, to a discriminator model, a first paired input comprising the tissue image and the output image based on the tissue image; ii) classifying, using the discriminator model, the output image based on the tissue image as belonging to a class selected from: A) generated images, wherein generated images is a class for all output images generated by the generator model; and B) target images, wherein target images is a class for all target images created in performing the set of training data creation steps; and b) training the generator model to create improved output images is further based on the discriminator model classifying the output image based on the tissue image as a generated image.

### Example 11

The system of example 10, wherein: a) the set of model training steps comprises: i) providing, to the discriminator model, a second paired input comprising the tissue image and the target image corresponding to the tissue image; ii) classifying, using the discriminator model, the output based on the tissue image as belonging to a class selected from: A) generated images; and B) target images; and b) training the discriminator model to create improved classifications based on the discriminator model classifying the target image corresponding to the tissue image as a generated image.

### Example 12

The system of example 11, wherein the set of model training steps comprises alternately training the generator model and the discriminator model on batches of tissue images, wherein the generator model is locked while the discriminator model is being trained, and wherein the discriminator model is locked while the generator model is being trained.

### Example 13

The system of example 10, wherein: a) the generator model is an encoder-decoder; and b) the discriminator model is a classifier configured to provide a classification of either generated image or target image for each of a plurality of patches each paired input.

### Example 14

The system of example 13, wherein the generator model is a U-Net encoder-decoder, and the discriminator model is a PatchGAN classifier.

### Example 15

A non-transitory computer readable medium storing computer executable instructions operable to program a computer comprising a processor to perform a method for training a machine learning model to add markings to representations of cell nuclei undergoing mitosis on tissue images, the method comprising: a) performing a set of training data creation steps comprising: i) receiving a tissue image comprising a set of representations of nuclei undergoing mitosis; and ii) create a target image corresponding to the tissue image by, for each representation of a nucleus undergoing mitosis from the set of representations of nuclei undergoing mitosis: A) receiving an identification of a centroid of that representation; B) adding a marking to the tissue image at the centroid for that representation, wherein the marking added to the tissue image at the centroid for that representation has a uniform size and shape with all other markings added to the tissue image during performance of the set of training data creation steps; and b) performing a set of model training steps comprising: i) providing, to a generator model, the tissue image; ii) generating an output image based on the tissue image using the generator model; and iii) training the generator model to create improved output images based on differences between: A) the output image based on the tissue image; and B) the target image corresponding to tissue image.

### Example 16

The computer readable medium of example 15, wherein: a) the set of model training steps comprises: i) providing, to a discriminator model, a first paired input comprising the tissue image and the output image based on the tissue image; ii) classifying, using the discriminator model, the output image based on the tissue image as belonging to a class selected from: A) generated images, wherein generated images is a class for all output images generated by the generator model; and B) target images, wherein target images is a class for all target images created in performing the set of training data creation steps; and b) training the generator model to create improved output images is further based on the discriminator model classifying the output image based on the tissue image as a generated image.

### Example 17

The computer readable medium of example 16, wherein: a) the set of model training steps comprises: i) providing, to the discriminator model, a second paired input comprising the tissue image and the target image corresponding to the tissue image; ii) classifying, using the discriminator model, the output based on the tissue image as belonging to a class selected from: A) generated images; and B) target images; and b) training the discriminator model to create improved classifications based on the discriminator model classifying the target image corresponding to the tissue image as a generated image.

### Example 18

The computer readable medium of example 17, wherein the set of model training steps comprises alternately training the generator model and the discriminator model on batches of tissue images, wherein the generator model is locked while the discriminator model is being trained, and wherein the discriminator model is locked while the generator model is being trained.

### Example 19

The computer readable medium of example 16, wherein: a) the generator model is an encoder-decoder; and b) the discriminator model is a classifier configured to provide a classification of either generated image or target image for each of a plurality of patches each paired input.

### Example 20

The computer readable medium of example 19, wherein the generator model is a U-Net encoder-decoder, and the discriminator model is a PatchGAN classifier.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general purpose dictionary, except that when a term or phrase is indicated as having a particular meaning under the heading Explicit Definitions, it should be understood as having that meaning when used in the claims.

### EXPLICIT DEFINITIONS

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and claims, the term “set” should be understood as one or more things which are grouped together. The terms “subset” and “superset” should be understood as being synonymous with “set,” with “set,” “subset” or “superset” being used for ease of reference rather than to convey a substantive difference.

What is claimed is:

1. A method comprising training a machine learning model to add markings to representations of nuclei undergoing mitosis on tissue images by:
a) performing a set of training data creation steps comprising:
i) receiving a tissue image comprising a set of representations of nuclei undergoing mitosis; and
ii) creating a target image corresponding to the tissue image by, for each representation of a nucleus undergoing mitosis from the set of representations of nuclei undergoing mitosis:
A) receiving an identification of a centroid of that representation;
B) adding a marking to the tissue image at the centroid for that representation, wherein the marking added to the tissue image at the centroid for that representation has a uniform size and shape with all other markings added to the tissue image during performance of the set of training data creation steps;
and
b) performing a set of model training steps comprising:
i) providing, to a generator model, the tissue image;
ii) generating an output image based on the tissue image using the generator model; and
iii) training the generator model to create improved output images based on differences between:
A) the output image based on the tissue image; and
B) the target image corresponding to tissue image.

2. The method of claim 1, wherein:
a) the set of model training steps comprises:
i) providing, to a discriminator model, a first paired input comprising the tissue image and the output image based on the tissue image;
ii) classifying, using the discriminator model, the output image based on the tissue image as belonging to a class selected from:
A) generated images, wherein generated images is a class for all output images generated by the generator model; and
B) target images, wherein target images is a class for all target images created in performing the set of training data creation steps;
and
b) training the generator model to create improved output images is further based on the discriminator model classifying the output image based on the tissue image as a generated image.

3. The method of claim 2, wherein:
a) the set of model training steps comprises:
i) providing, to the discriminator model, a second paired input comprising the tissue image and the target image corresponding to the tissue image;
ii) classifying, using the discriminator model, the output based on the tissue image as belonging to a class selected from:
A) generated images; and
B) target images;
and
b) training the discriminator model to create improved classifications based on the discriminator model classifying the target image corresponding to the tissue image as a generated image.

4. The method of claim 3, wherein the set of model training steps comprises alternately training the generator model and the discriminator model on batches of tissue images, wherein the generator model is locked while the discriminator model is being trained, and wherein the discriminator model is locked while the generator model is being trained.

5. The method of claim 2, wherein:
a) the generator model is an encoder-decoder; and
b) the discriminator model is a classifier configured to provide a classification of either generated image or target image for each of a plurality of patches each paired input.

6. The method of claim 5, wherein the generator model is a U-Net encoder-decoder, and the discriminator model is a PatchGAN classifier.

7. The method of claim 2, wherein the method comprises, after performing the set of model training steps configuring a computer to add markings to representations of nuclei undergoing mitosis in tissue images by configuring the computer with the generator model without configuring the computer with the discriminator model.

8. The method of claim 1, wherein the method comprises, after performing the set of model training steps, providing the generator model as the machine learning model to add markings to representations of nuclei undergoing mitosis on tissue images, wherein the generator model provided as the machine learning model to add markings to representations of nuclei undergoing mitosis on tissue images comprises one or more dropout layers.

9. A system for training a machine learning model to add markings to representations of cell nuclei undergoing mitosis on tissue images, the system comprising a processor configured with a set of computer executable instructions operable to, on execution, perform a method comprising:
a) performing a set of training data creation steps comprising:
i) receiving a tissue image comprising a set of representations of nuclei undergoing mitosis; and
ii) creating a target image corresponding to the tissue image by, for each representation of a nucleus undergoing mitosis from the set of representations of nuclei undergoing mitosis:
A) receiving an identification of a centroid of that representation;
B) adding a marking to the tissue image at the centroid for that representation, wherein the marking added to the tissue image at the centroid for that representation has a uniform size and shape with all other markings added to the tissue image during performance of the set of training data creation steps;
and
b) performing a set of model training steps comprising:
i) providing, to a generator model, the tissue image;
ii) generating an output image based on the tissue image using the generator model; and
iii) training the generator model to create improved output images based on differences between:
A) the output image based on the tissue image; and
B) the target image corresponding to tissue image.

10. The system of claim 9, wherein:
a) the set of model training steps comprises:
i) providing, to a discriminator model, a first paired input comprising the tissue image and the output image based on the tissue image;
ii) classifying, using the discriminator model, the output image based on the tissue image as belonging to a class selected from:
A) generated images, wherein generated images is a class for all output images generated by the generator model; and
B) target images, wherein target images is a class for all target images created in performing the set of training data creation steps;
and
b) training the generator model to create improved output images is further based on the discriminator model classifying the output image based on the tissue image as a generated image.

11. The system of claim 10, wherein:
a) the set of model training steps comprises:
i) providing, to the discriminator model, a second paired input comprising the tissue image and the target image corresponding to the tissue image;
ii) classifying, using the discriminator model, the output based on the tissue image as belonging to a class selected from:
A) generated images; and
B) target images;
and
b) training the discriminator model to create improved classifications based on the discriminator model classifying the target image corresponding to the tissue image as a generated image.

12. The system of claim 11, wherein the set of model training steps comprises alternately training the generator model and the discriminator model on batches of tissue images, wherein the generator model is locked while the discriminator model is being trained, and wherein the discriminator model is locked while the generator model is being trained.

13. The system of claim 10, wherein:
a) the generator model is an encoder-decoder; and
b) the discriminator model is a classifier configured to provide a classification of either generated image or target image for each of a plurality of patches each paired input.

14. The system of claim 13, wherein the generator model is a U-Net encoder-decoder, and the discriminator model is a PatchGAN classifier.

15. A non-transitory computer readable medium storing computer executable instructions operable to program a computer comprising a processor to perform a method for training a machine learning model to add markings to representations of cell nuclei undergoing mitosis on tissue images, the method comprising:
a) performing a set of training data creation steps comprising:
i) receiving a tissue image comprising a set of representations of nuclei undergoing mitosis; and
ii) creating a target image corresponding to the tissue image by, for each representation of a nucleus undergoing mitosis from the set of representations of nuclei undergoing mitosis:
A) receiving an identification of a centroid of that representation;
B) adding a marking to the tissue image at the centroid for that representation, wherein the marking added to the tissue image at the centroid for that representation has a uniform size and shape with all other markings added to the tissue image during performance of the set of training data creation steps;
and
b) performing a set of model training steps comprising:
i) providing, to a generator model, the tissue image;
ii) generating an output image based on the tissue image using the generator model; and
iii) training the generator model to create improved output images based on differences between:
A) the output image based on the tissue image; and
B) the target image corresponding to tissue image.

16. The computer readable medium of claim 15, wherein:
a) the set of model training steps comprises:
i) providing, to a discriminator model, a first paired input comprising the tissue image and the output image based on the tissue image;
ii) classifying, using the discriminator model, the output image based on the tissue image as belonging to a class selected from:
A) generated images, wherein generated images is a class for all output images generated by the generator model; and
B) target images, wherein target images is a class for all target images created in performing the set of training data creation steps;
and
b) training the generator model to create improved output images is further based on the discriminator model classifying the output image based on the tissue image as a generated image.

17. The computer readable medium of claim 16, wherein:
a) the set of model training steps comprises:
i) providing, to the discriminator model, a second paired input comprising the tissue image and the target image corresponding to the tissue image;
ii) classifying, using the discriminator model, the output based on the tissue image as belonging to a class selected from:
A) generated images; and
B) target images;
and
b) training the discriminator model to create improved classifications based on the discriminator model classifying the target image corresponding to the tissue image as a generated image.

18. The computer readable medium of claim 17, wherein the set of model training steps comprises alternately training the generator model and the discriminator model on batches of tissue images, wherein the generator model is locked while the discriminator model is being trained, and wherein the discriminator model is locked while the generator model is being trained.

19. The computer readable medium of claim 16, wherein:
a) the generator model is an encoder-decoder; and
b) the discriminator model is a classifier configured to provide a classification of either generated image or target image for each of a plurality of patches each paired input.

20. The computer readable medium of claim 19, wherein the generator model is a U-Net encoder-decoder, and the discriminator model is a PatchGAN classifier.
